(19) United States
(12) Patent Application Publication
(10) Pub. No.: US 2020/0183318 A1
(43) Pub. Date: Jun. 11, 2020

(54) STATIC ELIMINATION DEVICE AND MULTIFUNCTION MACHINE

(71) Applicant: SHARP KABUSHIKI KAISHA, Sakai City (JP)

(72) Inventor: HIROFUMI KANDA, Sakai City (JP)

(21) Appl. No.: 16/703,043

(22) Filed: Dec. 4, 2019

(30) Foreign Application Priority Data
Dec. 5, 2018 (JP) 2018-227894

(51) Int. Cl. G03G 21/08

(52) U.S. Cl. CPC G03G 21/08

(57) ABSTRACT

Provided is a light guide member rod-like in shape and usable in a static elimination device for eliminating static electricity from a static elimination object with light. The light guide member includes a facing surface that is a surface facing the static elimination object when viewed in cross section and has an invariable protruding shape in a protruding surface shape area as a first predetermined area of at least a part in a longitudinal direction, and a diffused reflection surface provided at a position inside the light guide member within a predetermined distance from an opposite surface to the facing surface in a diffused reflection surface area as a second predetermined area of at least a part in the longitudinal direction, the second predetermined area being identical to or different from the first predetermined area.

### BACKGROUND OF THE INVENTION

### Field of the Invention

The present invention relates to a static elimination device for eliminating static electricity from a photoconductor used for electrophotographic image formation, and a multifunction machine including the static elimination device.

### Description of the Background Art

In an electrophotographic image forming apparatus or a multifunction machine including the same, a process for charging the surface of a photosensitive drum, a process for forming a latent image on the photosensitive drum by exposing the same according to an image, a process for developing the latent image with a toner to form a toner image on the photosensitive drum, and a process for transferring the toner image from the photosensitive drum to a recording medium are performed in this order. The toner image transferred to the recording medium is fixed to the recording medium by a fixing process. In addition, subsequent to the process for transferring the toner image from the photosensitive drum to the recording medium, the photosensitive drum is advanced to a process for removing remaining toner and a process for removing remaining charge.

An image forming cycle is repeatedly applied to a rotating photosensitive drum, and thus, as illustrated in FIG. 1, a static elimination device 32 corresponding to the last static elimination process of the cycle and a charging device 24 corresponding to the first charging process of the cycle are arranged adjacently to the periphery of the photosensitive drum.

In order to reduce a size, it is necessary to make the static elimination device 32 and the charging device 24 adjacent to each other. In such a case, as illustrated in FIG. 1, a region 43 will be generated, in which a region 42 where the light emitted from the static elimination device 32 exists and a region 41 where charged particles 41 emitted from the charging device 24 exist overlap.

If the overlap region 43 is generated, the photosensitive drum 21 starts to be charged before it is sufficiently discharged, which may cause uneven charging and deteriorate an image quality.

In order to solve this problem, for example, there is a configuration that restricts light from the static elimination device along the rotation direction of a drum by arranging a partition between the static elimination device and the charging device. However, in this configuration, the problem arises due to the need to add the partition.

In addition, in the static elimination device, there is also a configuration in which a plurality of reflectors are provided on a light guide rod of edge light, and light is reflected in the direction of a photosensitive drum at an angle (Japanese Unexamined Patent Application Publication No. 2003-295717). However, in this configuration, there is a risk that the intensity of the reflected light will be different for each reflector included in the plurality of reflectors. In addition, in this configuration, in principle, there is a risk that the reflected light is non-uniform due to the pitch of the arrangement of the reflectors.

In view of the above, an object of the present invention is to provide a static elimination device in which light emitted from the static elimination device becomes uniform with a simple configuration and a multifunction machine including the static elimination device.

### SUMMARY OF THE INVENTION

According to the present invention, there is provided a light guide member rod-like in shape and usable in a static elimination device for eliminating static electricity from a static elimination object with light. The light guide member includes a facing surface that is a surface facing the static elimination object when viewed in cross section and has an invariable protruding shape in a protruding surface shape area as a first predetermined area of at least a part in a longitudinal direction, and a diffused reflection surface provided at a position on an opposite surface to the facing surface or a position inside the light guide member within a predetermined distance from the opposite surface in a diffused reflection surface area as a second predetermined area of at least a part in the longitudinal direction, the second predetermined area being identical to or different from the first predetermined area.

In addition, according to the present invention, there is provided a static elimination device including: the abovementioned light guide member; and one or more light sources that make light enter the light guide member through one or both of two end faces in the longitudinal direction of the light guide member.

Furthermore, according to the present invention, there is provided a multifunction machine including the abovementioned static elimination device.

According to the present invention, the light emitted from the static elimination device becomes uniform with a simple configuration.

### BRIEF DESCRIPTION OF THE DRAWINGS

FIG. 1 is a cross-sectional view illustrating a photosensitive drum, a static elimination device, and a charging device of a conventional image forming apparatus.

FIG. 2 is a cross-sectional view illustrating a main part of an image forming apparatus according to a first embodiment of the present invention.

FIG. 3 is a perspective view illustrating a photosensitive drum, a static elimination device, and a charging device of the image forming apparatus according to the first embodiment of the present invention.

FIG. 4 is a perspective view illustrating the photosensitive drum, static elimination device, and charging device of the image forming apparatus according to the first embodiment of the present invention.

FIG. 5 is a top view, a front view, a bottom view, a left side view, a right side view, and an A-A′ side view illustrating a shape of a static elimination device according to a second embodiment of the present invention.

FIG. 6 is a top view, a front view, a bottom view, a left side view, a right side view, and an A-A′ side view illustrating a shape of a static elimination device according to a third embodiment of the present invention.

FIG. 7 is a top view, a front view, a bottom view, a left side view, a right side view, and an A-A′ side view illustrating a shape of a static elimination device according to a fourth embodiment of the present invention.

FIG. 8 is a top view, a front view, a bottom view, a left side view, a right side view, and an A-A′ side view illustrating a shape of a static elimination device according to a fifth embodiment of the present invention.

FIG. 9 is a top view, a front view, a bottom view, a left side view, a right side view, and an A-A′ side view illustrating a shape of a static elimination device according to a sixth embodiment of the present invention.

FIG. 10 is a top view, a front view, a bottom view, a left side view, a right side view, and an A-A′ side view illustrating a shape of a static elimination device according to a seventh embodiment of the present invention.

FIG. 11 is a top view, a front view, a bottom view, a left side view, a right side view, and an A-A′ side view illustrating a shape of a static elimination device according to an eighth embodiment of the present invention.

FIG. 12 is a top view, a front view, a bottom view, a left side view, a right side view, and an A-A′ side view illustrating a shape of a static elimination device according to a ninth embodiment of the present invention.

FIG. 13 is a top view, a front view, a bottom view, a left side view, a right side view, and an A-A′ side view illustrating a shape of a static elimination device according to a tenth embodiment of the present invention.

FIG. 14 is a top view, a front view, a bottom view, a left side view, a right side view, and an A-A′ side view illustrating a shape of a static elimination device according to an eleventh embodiment of the present invention.

FIG. 15 is a top view, a front view, a bottom view, a left side view, a right side view, and an A-A′ side view illustrating a shape of a static elimination device according to a twelfth embodiment of the present invention.

FIG. 16 is a top view, a front view, a bottom view, a left side view, a right side view, and an A-A′ side view illustrating a shape of a static elimination device according to a thirteenth embodiment of the present invention.

FIG. 17 is a top view, a front view, a bottom view, a left side view, a right side view, and an A-A′ side view illustrating a shape of a static elimination device according to a fourteenth embodiment of the present invention.

FIG. 18 is a top view, a front view, a bottom view, a left side view, a right side view, and an A-A′ side view illustrating a shape of a static elimination device according to a fifteenth embodiment of the present invention.

FIG. 19 is a left side view illustrating a shape of a static elimination device according to a sixteenth embodiment of the present invention.

FIG. 20 is a left side view illustrating a shape of a static elimination device according to a seventeenth embodiment of the present invention.

FIG. 21 is a left side view illustrating a shape of a static elimination device according to an eighteenth embodiment of the present invention.

FIG. 22 is a left side view illustrating another shape of the static elimination device according to the eighteenth embodiment of the present invention.

FIG. 23 is a left side view illustrating a further other shape of a static elimination device according to the eighteenth embodiment of the present invention.

FIG. 24 is a left side view illustrating a further other shape of a static elimination device according to the eighteenth embodiment of the present invention.

### DESCRIPTION OF THE PREFERRED EMBODIMENTS

Hereinafter, embodiments for carrying out the present invention will be described in detail with reference to the drawings.

### First Embodiment

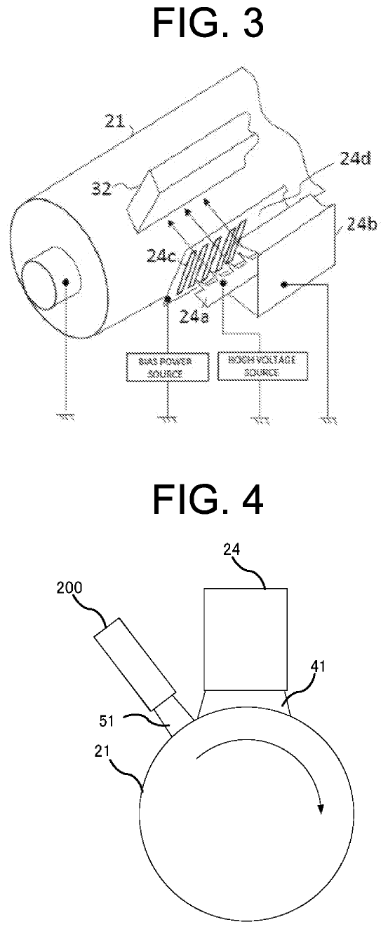

FIG. 2 is a schematic side view illustrating a configuration of a part related to image formation of a multifunction machine according to a first embodiment of the present invention. FIG. 3 is a perspective view for schematically explaining the arrangement of a static elimination device 200.

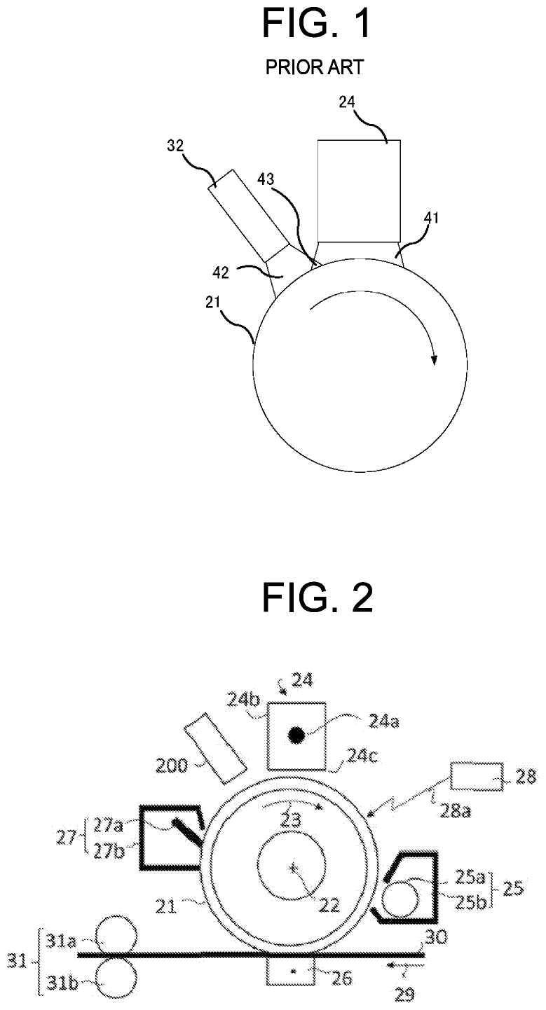

Compared to a region 42 where the light emitted from a static elimination device 32 illustrated in FIG. 1 is present, a region 51 where the light emitted from a static elimination device 200 illustrated in FIG. 4 is present is narrowed in the rotation direction of a photosensitive drum 21. Thus, the region 51 does not overlap with a region 41 where charged particles 41 emitted from a charging device 24 are present. The configuration of the static elimination device 200 will be described later.

The image forming apparatus in FIG. 2 includes the photosensitive drum 21, a charging device 24 that charges the photosensitive drum 21, an exposure device 28 that exposes the charged photosensitive drum 21 to form an electrostatic latent image, a developing device 25 that develops with a toner the electrostatic latent image formed by exposure to form a toner image, a transfer device 26 that transfers the toner image formed by development onto a recording material, a cleaner 27 that collects toner remaining on the photosensitive drum 21, a fixing device 31 that fixes the transferred toner image onto the recording material to form an image, and the static elimination device 200 that eliminates static electricity from the photosensitive drum 21. A transfer paper 30 becomes a recording material, passes between the photosensitive drum 21 and the transfer device 26, and the toner image is transferred from the photosensitive drum 21 to the transfer paper 30.

The photosensitive drum 21 is rotatably supported by a main body (not illustrated) of the image forming apparatus, and is driven to rotate in the direction of an arrow 23 about a rotation axis 22 by a driving device (not illustrated). The driving device includes, for example, an electric motor and a reduction gear. The driving force is transmitted to a conductive support that forms the core of the photosensitive drum 21, and the photosensitive drum 21 is thereby rotated at a predetermined peripheral speed. The charging device 24, exposure device 28, developing device 25, transfer device 26, cleaner 27, and static elimination device 200 are provided in this order, from the upstream side toward the downstream side of the rotating direction of the photosensitive drum 21 indicated by the arrow 23, along the outer peripheral surface of the photosensitive drum 21.

The charging device 24 charges the outer peripheral surface of the photosensitive drum 21 to a predetermined potential. As the charging device 24, for example, a scorotron charging device is used, and a sawtooth electrode 24a, a shield case 24b, and a grid 24c disposed between the photosensitive drum 21 and the sawtooth electrode 24a are included. The sawtooth electrode 24a is attached to a holding member (not illustrated) made of an insulating synthetic resin, and the holding member to which the sawtooth electrode 24a is attached is housed in the shield case 24b.

The static elimination device 200 irradiates the photosensitive drum 21 with static elimination light to remove the charge remaining on the photosensitive drum 21 after the toner remaining on the photosensitive drum is collected by the cleaner 27. Hereinafter, a region on the photosensitive drum 21 where the static elimination light is irradiated by the static elimination device 200 is called a static elimination light irradiation region.

The exposure device 28 includes, for example, a semiconductor laser as a light source. The photosensitive drum 21 is irradiated with light 28a such as a laser beam output from the light source during the period of movement between the charging device 24 and the developing device 25. By the irradiation with the light 28a, the outer peripheral surface of the charged photosensitive drum 21 is exposed according to image information. The light 28a is repeatedly scanned in the direction in which the rotation axis 22 of the photosensitive drum 21 extends, which is a main scanning direction, and a main scanning position moves in a sub-scanning direction according to the rotation of the photosensitive drum 21. Accordingly, electrostatic latent images are sequentially formed on the surface of the photosensitive drum 21.

The developing device 25 is a developer that develops, with a developing agent, the electrostatic latent image formed on the surface of the photosensitive drum 21 by exposure. The developing device 25 is provided so as to face the photosensitive drum 21, and includes: a developing roller 25a that supplies toner to the outer peripheral surface of the photosensitive drum 21; and a casing 25b that supports the developing roller 25a so as to be rotatable around a rotation axis parallel to the rotation axis 22 of the photosensitive drum 21 and that houses the developing agent containing toner in the internal space of the casing 25b.

The transfer device 26 is a transferer that transfers, a toner image that is a visible image formed on the outer peripheral surface of the photosensitive drum 21 by development, onto a transfer paper 30 that is a recording material (recording medium) supplied between the photosensitive drum 21 and the transfer device 26 from the direction of an arrow 29 by a conveyer (not illustrated). The transfer device 26 includes, for example, a charger, and is a non-contact type transferer that transfers a toner image onto the transfer paper 30 by giving the transfer paper 30 a charge with a polarity opposite to the toner.

The cleaner 27 is a cleaner that removes and collects the toner remaining on the outer peripheral surface of the photosensitive drum 21 after the transfer operation by the transfer device 26, and includes a cleaning blade 27a that peels off the toner remaining on the outer peripheral surface of photosensitive drum 21 and a recovery casing 27b that houses the toner peeled off by the cleaning blade 27a.

In addition, the image forming apparatus is provided with a fixing device 31 that fixes a transferred image on the downstream side where the transfer paper 30 that has passed between the photosensitive drum 21 and the transfer device 26 is conveyed. The fixing device 31 includes a heating roller 31a having a heater (not illustrated) and a pressure roller 31b which is provided facing the heating roller 31a and is pressed by the heating roller 31a to form a contact portion.

The image forming operation by this image forming apparatus is performed as follows. First, when the photosensitive drum 21 is driven to rotate in the direction of the arrow 23 by the driving device, the surface of the photosensitive drum 21 is uniformly charged to a predetermined positive or negative potential by the charging device 24 provided on a more upstream side in the rotation direction of the photosensitive drum 21 than the image forming point of the light 28a by the exposure device 28.

Next, the light 28a corresponding to the image information is irradiated from the exposure device 28 to the surface of the photosensitive drum 21. In the photosensitive drum 21, the surface charge of the portion irradiated with the light 28a is removed by this exposure. Thus, a difference occurs between the surface potential of the portion irradiated with the light 28a and the surface potential of the portion not irradiated with the light 28a, and an electrostatic latent image is formed.

Next, a toner is supplied to the surface of the photosensitive drum 21 on which the electrostatic latent image has been formed from the developing device 25 provided on a more downstream side in the rotation direction of the photosensitive drum 21 than the image forming point of the light 28a by the exposure device 28, the electrostatic latent image is developed, and a toner image is formed.

In synchronization with the exposure to the photosensitive drum 21, the transfer paper 30 is supplied between the photosensitive drum 21 and the transfer device 26. The transfer device 26 charges the supplied transfer paper 30 with a polarity opposite to the toner. The toner image formed on the surface of the photosensitive drum 21 is transferred onto the transfer paper 30.

Next, the transfer paper 30 on which the toner image has been transferred is conveyed to the fixing device 31 by the conveyer, and is heated and pressurized when passing through the contact portion between the heating roller 31a and the pressure roller 31b of the fixing device 31. The toner image is fixed on the transfer paper 30 and becomes a robust image. The transfer paper 30 on which the image is formed in this way is ejected to the outside of the image forming apparatus by the conveyer.

Meanwhile, the toner remaining on the surface of the photosensitive drum 21 after the transfer of the toner image by the transfer device 26 is peeled off and collected from the surface of the photosensitive drum 21 by the cleaner 27. The charge on the surface of the photosensitive drum 21 from which the toner has been removed in this way is removed by the static elimination light from the static elimination device 200, and the electrostatic latent image on the surface of the photosensitive drum 21 disappears. Thereafter, the photosensitive drum 21 is further driven to rotate, and images are continuously formed by repeating a series of operations starting from charging again.

The basic configuration according to the first embodiment can be applied to the following embodiments.

### Second Embodiment

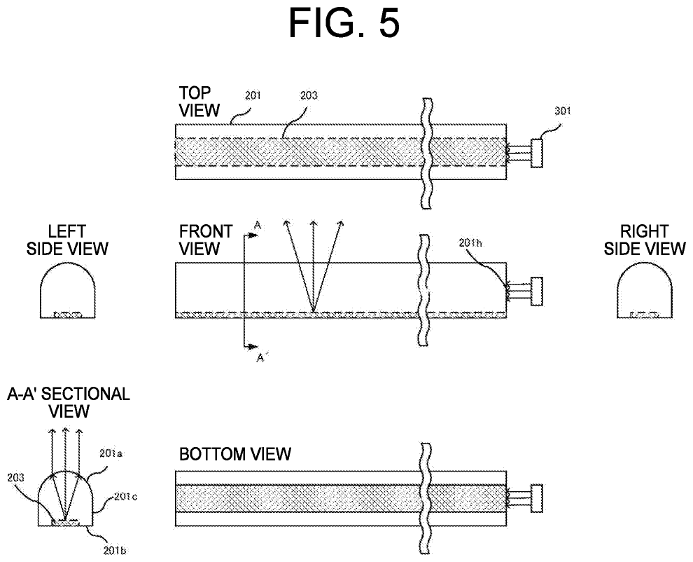

Referring to FIG. 5, the static elimination device according to the second embodiment includes a light guide member 201 and a light source 301.

The light guide member 201 has a rod-like shape, and in the whole area in the longitudinal direction, a facing surface 201a that is a surface facing the static elimination object when viewed in cross section has an invariable protruding shape, and in the whole area in the longitudinal direction, a diffused reflection surface is included at a position inside the light guide member 201 within a predetermined distance from an opposite surface 201b to the facing surface 201a. That is, a diffused reflection surface 203 may be formed in the opposite surface 201b per se, or may be formed at a position inside the light guide member 201 that is separated from the opposite surface 201b by a predetermined distance. In addition, the diffused reflection surface 203 is preferably formed around a flat surface, although not indispensably.

As the material of the light guide member 201, a transparent or translucent material having a refractive index higher than that of the surrounding space is used. For example, acrylic can be used.

In addition, the light source 301 causes light enter at least one end face in the longitudinal direction of the light guide member 201. Unlike FIG. 5, the light source 301 is actually joined to the light guide member 201.

The light emitted from the light source 301 enters the light guide member 201 through a light entrance portion 201h joined to the light source 301.

Light incident from the inside of the light guide member 201 to the outer surface of the light guide member 201 at an incident angle greater than a critical angle is totally reflected on the outer surface and returns to the light guide member 201.

A part of the light incident on the diffused reflection surface 203 from the inside of the light guide member 201 fulfills the condition of total reflection, and thus diffused reflection light is emitted from the diffused reflection surface 203 into the light guide member 201. Part of such diffused reflection light reaches the facing surface 201a. The cross-sectional shape (height, width, etc.) is adjusted in such a manner that the light reaching the protruding surface shape area of the facing surface 201a from the diffused reflection surface 203 does not fulfill the condition of total reflection, and thus such light is emitted to the outside. In particular, such light emitted from the protruding surface shape area is emitted to the outside while being so refracted as to be more approximate to parallel light than before being refracted over the protruding surface shape area when viewed in cross section.

In particular, the protruding shape constitutes a cylindrical lens, but may be a shape that forms a collimator lens. Furthermore, compared to a case of a collimator shape, a shape by which emitted light is condensed on the surface of a photosensitive drum when viewed in cross section may be employed, or conversely, a shape by which emitted light is dispersed to some extent may be employed.

In the longitudinal direction, the light diffused by the diffused reflection surface 203 and reaching the facing surface 201a is refracted and emitted at an angle corresponding to the incident angle on the facing surface 201a and the refractive index on both sides of the surface. In FIG. 5, the light is drawn so as not to be refracted, but it is only so on the drawing.

Therefore, it is possible to irradiate, from the light guide member 201, the surface of the photosensitive drum 21 with strip-shaped parallel light, strip-shaped narrowed in the width direction, or light dispersed to some extent in the width direction. Even if the static elimination device 200 and the charging device 24 are close to each other, it is possible to avoid that the region irradiated with the static elimination light on the surface of photosensitive drum 21 overlaps with the region where charged particles from the charging device 24 reach. Therefore, the entire device can be downsized.

In addition, since the light emitted from the facing surface 201a of the light guide member 201 is the diffused reflected light by the diffused reflection surface 203 and thus is fairly uniform even in a short direction in which the protruding shape of the facing surface 201a affects. In particular, the light is uniform in the longitudinal direction in which the protruding shape of the facing surface 201a does not affect. Therefore, it is possible to uniformly eliminate static electricity from the photosensitive drum 21. In particular, it is possible to uniformly eliminate static electricity in the main scanning direction, which is the longitudinal direction. In the sub-scanning direction, which is the short direction, it is still possible to uniformly eliminate static electricity by rotating the photosensitive drum 21 in that direction. Therefore, it is possible to uniformly eliminate static electricity from the entire surface of the photosensitive drum 21.

The diffused reflection surface 203 can be formed by, for example, blasting.

As the light guide member 201 according to the present embodiment, a light guide member 201 having a same cross-sectional shape from one end to the other end in the longitudinal direction can be used. Such light guide member 201 can be manufactured accurately and inexpensively by extrusion molding. The same applies to the light guide member 201 according to the following embodiments.

### Third Embodiment

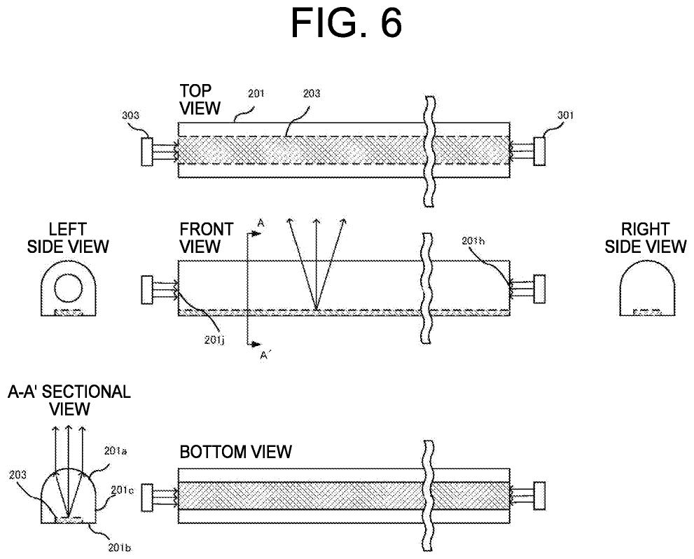

FIG. 6 illustrates a static elimination device according to the third embodiment. The difference from the static elimination device according to the second embodiment illustrated in FIG. 5 is that, in the static elimination device according to the second embodiment, the light from only one light source 301 reaches the light entrance portion 201h at one end of the light guide member 201, whereas in the static elimination device according to the third embodiment, the light from two light sources 301 and 303 reaches light entrance portions 201h and 201j (actually joined to the light sources 301 and 303, respectively, unlike FIG. 6) at both ends of the light guide member 201.

Therefore, when the same light source is used, in the third embodiment, it is possible to irradiate the photosensitive drum 21 with light twice as strong as that in the second embodiment.

### Fourth Embodiment

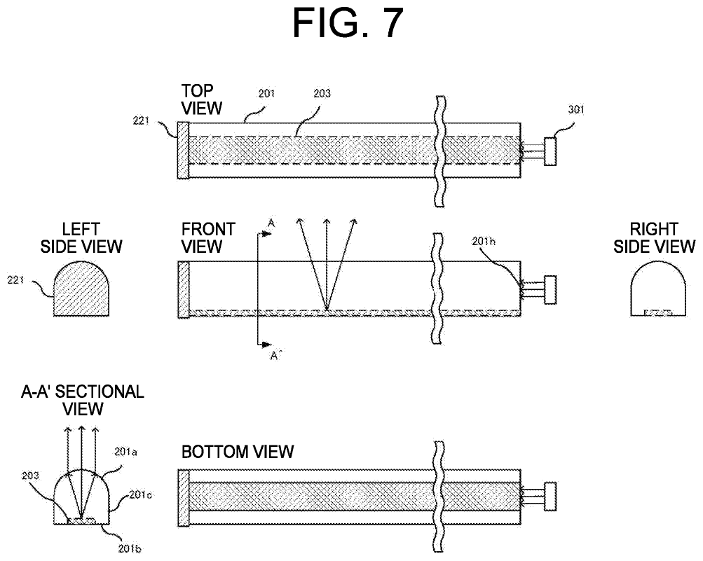

FIG. 7 illustrates a static elimination device according to the fourth embodiment. The difference from the static elimination device according to the second embodiment illustrated in FIG. 5 is that, in the static elimination device according to the second embodiment, there are no other parts at the opposite end of one end where the light enters from the light source 301, whereas in the static elimination device according to the fourth embodiment, a reflection member 221 is disposed at the opposite end of one end where the light enters from the light source 301. Note that a reflection film may be provided as an alternative to the reflection member 221. In the present invention, the reflection member includes a reflection film.

The reflection member 221 reflects, the light reaching the opposite end from the light source 301, toward the light guide member 201. Thus, compared to the static elimination device according to the second embodiment without such reflection, the intensity of the light emitted from the facing surface 201a of the light guide member 201 is increased.

### Fifth Embodiment

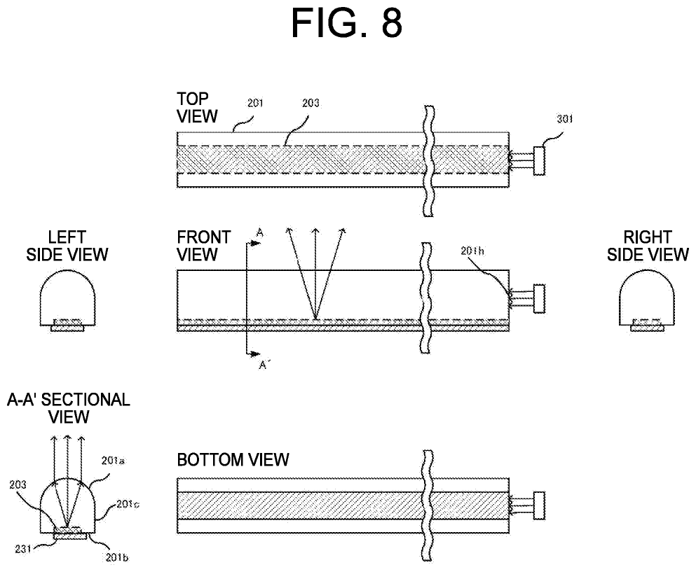

FIG. 8 illustrates a static elimination device according to the fifth embodiment. The difference from the static elimination device according to the second embodiment illustrated in FIG. 5 is that, in the static elimination device according to the second embodiment, there are no other parts in the opposite surface 201b, whereas in the static elimination device according to the fifth embodiment, a reflection member 231 is disposed in the opposite surface 201b.

The reflection member 231 may be adjacent to the diffused reflection surface 203. In particular, the reflection member 231 may have an uneven surface that matches the uneven surface of the diffused reflection surface 203, and both uneven surfaces may be in contact with no gap.

Moreover, the reflection member 231 may be disposed at a position away from the diffused reflection surface 203 by a predetermined distance. For example, the reflection member 231 is disposed in this way in a case where the diffused reflection surface 203 is disposed inside the light guide member 201 and the reflection member 231 is disposed on the surface of the opposite surface 201b.

Therefore, the light to be emitted from the opposite surface 201b to the outside of the light guide member 201 is reflected by the reflection member 231 and returns to the inside. Thus, compared to the static elimination device according to the second embodiment without such reflection, the intensity of the light emitted from the facing surface 201a of the light guide member 201 is increased accordingly.

### Sixth Embodiment

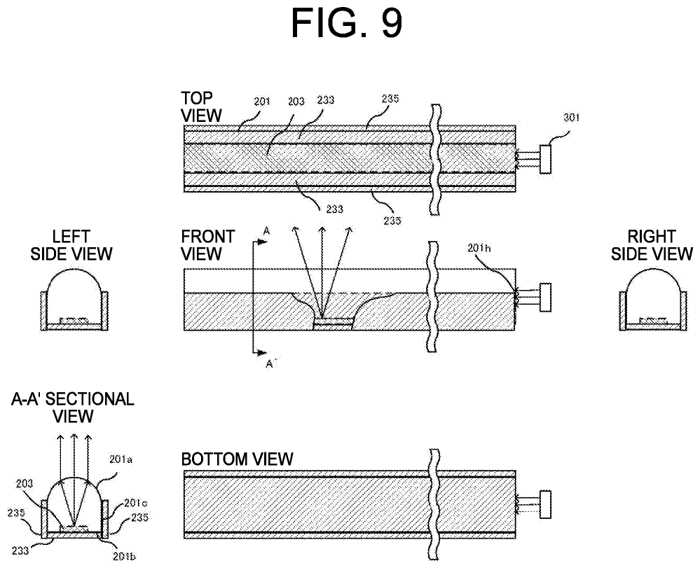

FIG. 9 illustrates a static elimination device according to the sixth embodiment. The difference from the static elimination device according to the second embodiment illustrated in FIG. 5 is that, in the static elimination device according to the second embodiment, there are no other parts in the opposite surface 201b and a side face 201c, whereas in the static elimination device according to the sixth embodiment, a reflection member 233 is disposed in the opposite surface 201b and a reflection member 235 is also disposed in both side faces 201c.

In addition, the reflection member 235 may be disposed only in a part of the both side faces 201c, or may be disposed in the entire region.

Therefore, the light to be emitted from the opposite surface 201b to the outside of the light guide member 201 is reflected by the reflection member 233 and returns to the inside and the light to be emitted from each side face 201c to the outside of the light guide member 201 is reflected by the reflection member 235 and returns to the inside. Thus, compared to the static elimination device according to the second embodiment without such reflection, the intensity of the light emitted from the facing surface 201a of the light guide member 201 is increased accordingly.

### Seventh Embodiment

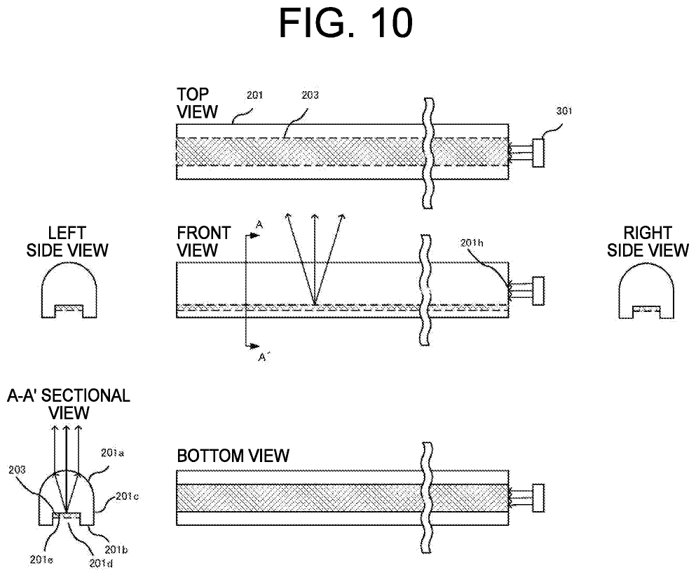

FIG. 10 illustrates a static elimination device according to the seventh embodiment. The difference from the static elimination device according to the second embodiment illustrated in FIG. 5 is that, in the static elimination device according to the second embodiment, the diffused reflection surface 203 is included in the flat opposite surface 201b, whereas in the static elimination device according to the seventh embodiment, a groove 201d that is opened to the opposite surface 201b and extends in the longitudinal direction is included in the light guide member 201, and the diffused reflection surface 203 is included in this groove 201d.

Therefore, the diffused reflection surface 203 is protected against contact from the outside.

By making the groove 201d thinner, the emitted light can be made thinner. Conversely, by making the groove 201d thicker, the emission efficiency can be increased.

### Eighth Embodiment

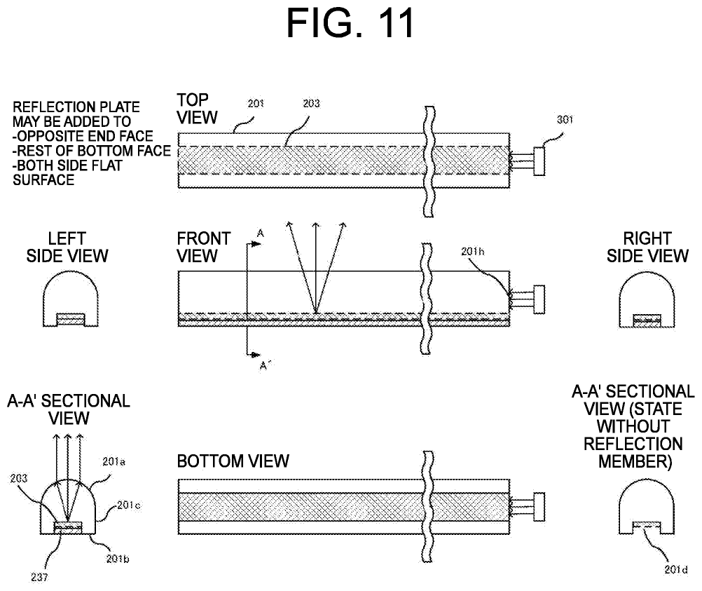

FIG. 11 illustrates a static elimination device according to the eighth embodiment. The difference from the static elimination device according to the seventh embodiment illustrated in FIG. 10 is that, in the static elimination device according to the seventh embodiment, there are no other parts in the groove 201d, whereas in the static elimination device according to the eighth embodiment, a reflection member 237 is disposed in the groove 201d.

Therefore, the diffused reflection surface 203 is protected against contact from the outside. The reflection member 237 is also protected from contact from the outside.

The optical effect by disposing the reflection member 237 is as described above.

### Ninth Embodiment

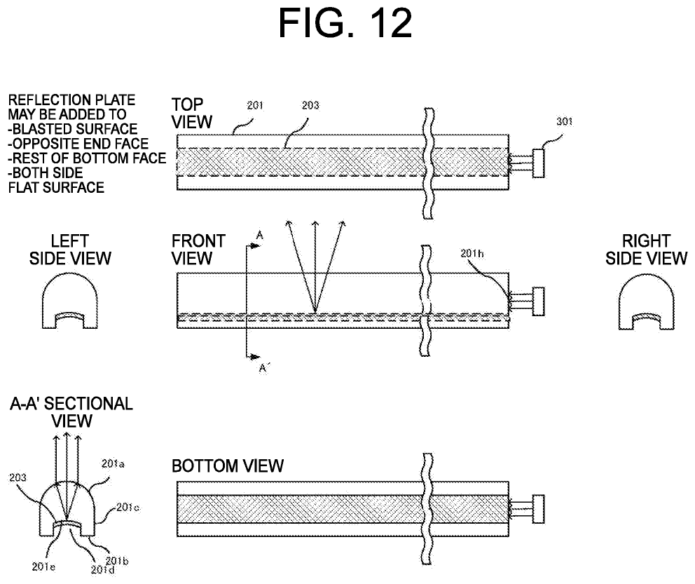

FIG. 12 illustrates a static elimination device according to the ninth embodiment. The difference from the static elimination device according to the seventh embodiment illustrated in FIG. 10 is that, in the static elimination device according to the seventh embodiment, the cross-sectional shape of the bottom of the groove 201d is linear, whereas in the static elimination device according to the ninth embodiment, the cross-sectional shape of the bottom of the groove 201d is a recessed shape such that the closer the cross-sectional shape of the bottom of the groove 201d is to the center, the deeper the groove 201d becomes.

Therefore, even if the protruding shape of the facing surface 201a is the same as that of the seventh embodiment, the width in the short direction of the light emitted from the facing surface 201a can be widened compared to the seventh embodiment.

### Tenth Embodiment

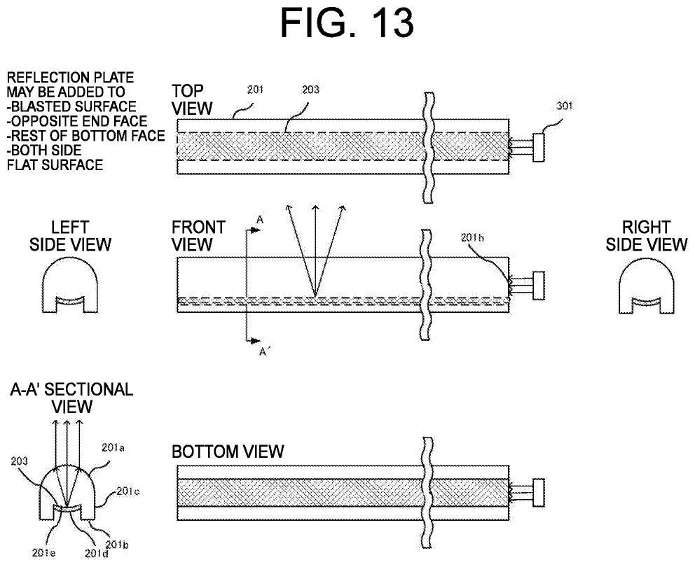

FIG. 13 illustrates a static elimination device according to the tenth embodiment. The difference from the static elimination device according to the seventh embodiment illustrated in FIG. 10 is that, in the static elimination device according to the seventh embodiment, the cross-sectional shape of the bottom of the groove 201d is linear, whereas in the static elimination device according to the tenth embodiment, the cross-sectional shape of the bottom of the groove 201d is a protruding shape such that the closer the cross-sectional shape of the bottom of the groove 201d is to the center, the shallower the groove 201d becomes.

Therefore, even if the protruding shape of the facing surface 201a is the same as that of the seventh embodiment, the width in the short direction of the light emitted from the facing surface 201a can be narrowed compared to the seventh embodiment.

### Eleventh Embodiment

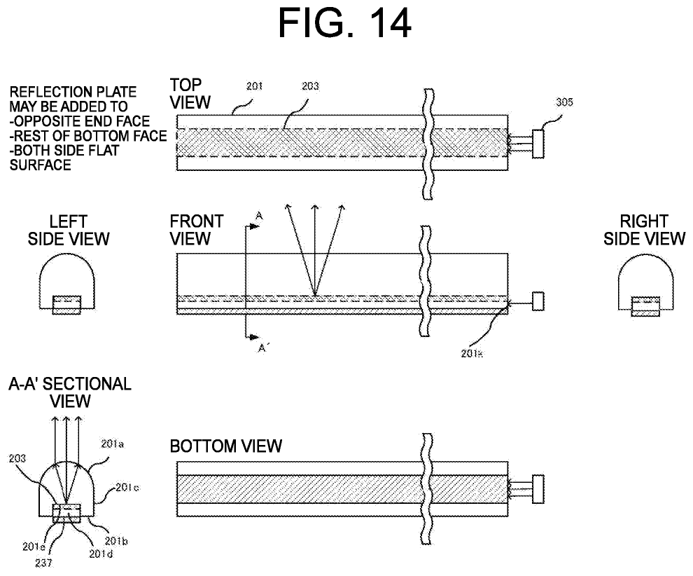

FIG. 14 illustrates a static elimination device according to the eleventh embodiment. The difference from the static elimination device according to the seventh embodiment illustrated in FIG. 10 is that, in the static elimination device according to the seventh embodiment, the light emitted from the light source 301 reaches the light entrance portion 201h at one end of the light guide member 201, whereas in the static elimination device according to the eleventh embodiment, the light emitted from a light source 305 reaches a light entrance portion 201k. The light guide member 201 actually exists in the light entrance portion 201h, but the light guide member 201 does not actually exist in the light entrance portion 201k.

In addition, in the static elimination device according to the seventh embodiment, there are no other parts around the groove 201d, whereas in the static elimination device according to the eleventh embodiment, the reflection member 237 is disposed at a position separated from the bottom of the groove 201d so as to cover the groove 201d.

The light entrance portion 201k is located at one end of the groove 201d, and the light incident on the groove 201d from here is totally reflected by the reflection member 237 and the diffused reflection surface 203 depending on the incident angle, and travels through the groove 201d while including a diffused reflection component. Part of the light reaching the diffused reflection surface 203 through the groove 201d enters the light guide member 201, passes through the inside of the light guide member 201 and reaches the facing surface 201a, is refracted at the surface, and is emitted to the outside from the facing surface 201a. The remaining part of the light reaching the diffused reflection surface 203 through the groove 201d returns to the groove 201d.

For example, in the second embodiment, if the joining state of the light source 301 and the light entrance portion 201h is not good, the light incident efficiency when the light emitted from the light source 301 enters the light entrance portion 201h may drop.

On the other hand, the light from the light source 305 enters the groove 201d with the light incident efficiency 100%.

Another light source may be disposed on the end face side opposite to the end face of a side on which the light source 305 of the light guide member 201 is disposed in such a manner that light enters the groove 201d through both end faces.

### Twelfth Embodiment

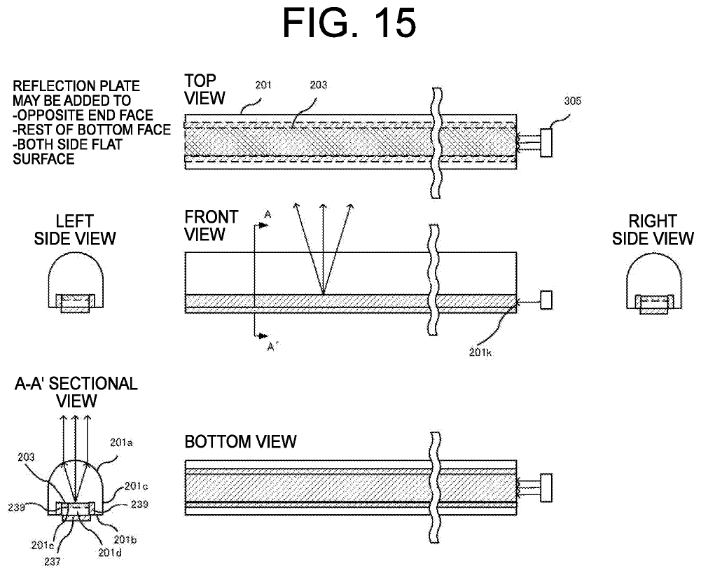

FIG. 15 illustrates a static elimination device according to the twelfth embodiment. The difference from the static elimination device according to the eleventh embodiment illustrated in FIG. 14 is that, in the static elimination device according to the eleventh embodiment, there are no other parts in the inner face of the groove 201d, whereas in the static elimination device according to the twelfth embodiment, a reflection member 239 is disposed in the inner face of the groove 201d.

The light entrance portion 201k is located at one end of the groove 201d, and the light incident from here is totally reflected by the reflection member 237 and the diffused reflection surface 203 depending on the incident angle, and travels through the groove 201d while containing a diffused reflection component. Part of the light reaching the diffused reflection surface 203 through the groove 201d enters the light guide member 201, passes through the inside of the light guide member 201 and reaches the facing surface 201a, is refracted at the surface, and is emitted to the outside from the facing surface 201a. The remaining part of the light reaching the diffused reflection surface 203 through the groove 201d returns to the groove 201d.

In addition, the light incident on the reflection member 239 through the groove 201d at any incident angle is reflected here and returns to the groove 201d.

### Thirteenth Embodiment

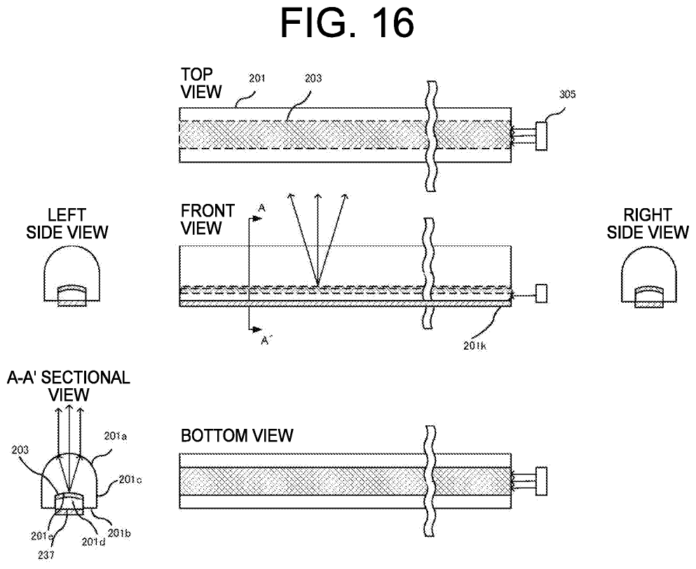

FIG. 16 illustrates a static elimination device according to the thirteenth embodiment. The difference from the static elimination device according to the eleventh embodiment illustrated in FIG. 14 is that, in the static elimination device according to the eleventh embodiment, the cross-sectional shape of the bottom of the groove 201d is linear, whereas in the static elimination device according to the thirteenth embodiment, the cross-sectional shape of the bottom of the groove 201d is a recessed shape such that the closer the cross-sectional shape of the bottom of the groove 201d is to the center, the deeper the groove 201d becomes.

Therefore, even if the protruding shape of the facing surface 201a is the same as that of the eleventh embodiment, the width in the short direction of the light emitted from the facing surface 201a can be widened compared to the eleventh embodiment.

### Fourteenth Embodiment

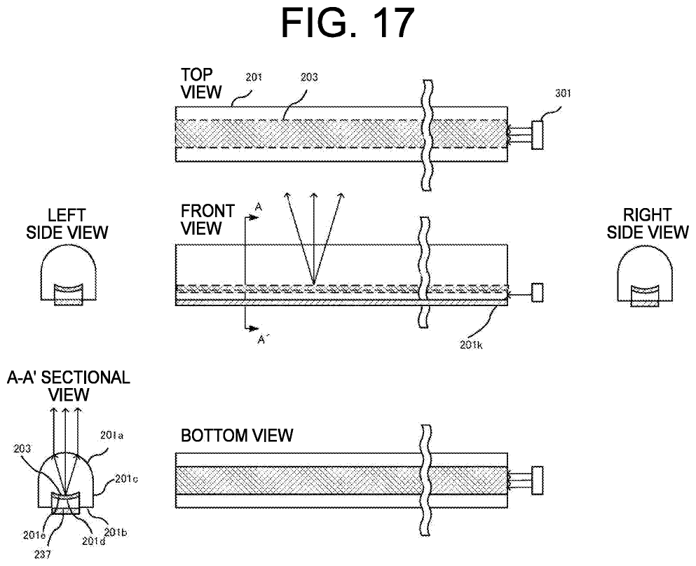

FIG. 17 illustrates a static elimination device according to the fourteenth embodiment. The difference from the static elimination device according to the eleventh embodiment illustrated in FIG. 14 is that, in the static elimination device according to the eleventh embodiment, the cross-sectional shape of the bottom of the groove 201d is linear, whereas in the static elimination device according to the fourteenth embodiment, the cross-sectional shape of the bottom of the groove 201d is a protruding shape such that the closer the cross-sectional shape of the bottom of the groove 201d is to the center, the shallower the groove 201d becomes.

Therefore, even if the protruding shape of the facing surface 201a is the same as that of the eleventh embodiment, the width in the short direction of the light emitted from the facing surface 201a can be narrowed compared to the eleventh embodiment.

### Fifteenth Embodiment

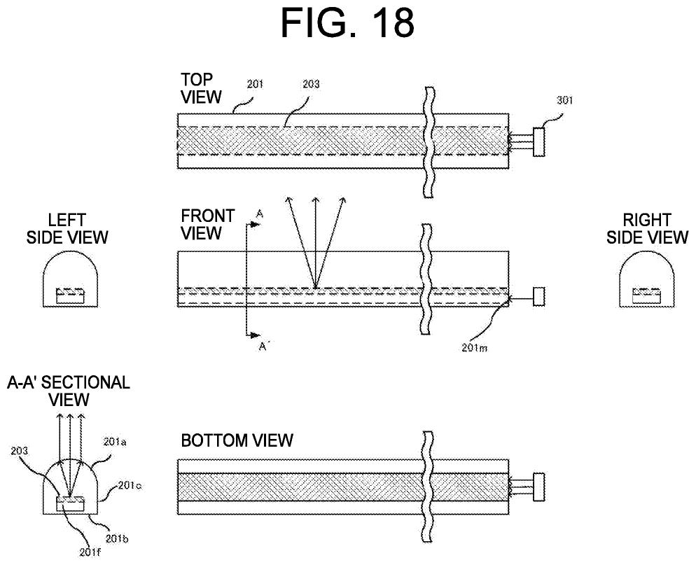

FIG. 18 illustrates a static elimination device according to the fifteenth embodiment. The difference from the static elimination device according to the second embodiment illustrated in FIG. 5 is that, in the static elimination device according to the second embodiment, the inside of the light guide member 201 is filled with a predetermined material, whereas in the static elimination device according to the fifteenth embodiment, a first hollow hole 201f is provided inside the light guide member 201.

In addition, the inner wall on the static elimination object side of the first hollow hole 201f has a linear shape when viewed in cross section.

In the configuration of FIG. 18, the first hollow hole 201f extends over the entire length in the longitudinal direction of the light guide member 201 so as to have a first opening on one end face in the longitudinal direction of the light guide member 201 and a second opening on the other end face. The light emitted from the light source 301 enters the first hollow hole 201f through the first opening. Note that, the first hollow hole 201f may extend over a partial length in the longitudinal direction of the light guide member 201 so as to close, having a first opening on one end face in the longitudinal direction of the light guide member 201 and not having a second opening on the other end face, and the light emitted from the light source 301 may enter the first hollow hole 201f through the first opening.

The first hollow hole 201f is filled with a second light guide member having a refractive index higher than that of the light guide member 201. Therefore, the light incident from the first opening is totally reflected at the boundary between the light guide member 201 and the first hollow hole 201f depending on the incident angle, and travels through the first hollow hole 201f while containing a diffused reflection component. Part of the light incident on the diffused reflection surface 203 from the first hollow hole 201f is diffusely reflected here and incident on the inside of the light guide member 201, and then emitted from the facing surface 201a.

The light may be incident on the first hollow hole 201f through the first opening and the second opening.

### Sixteenth Embodiment

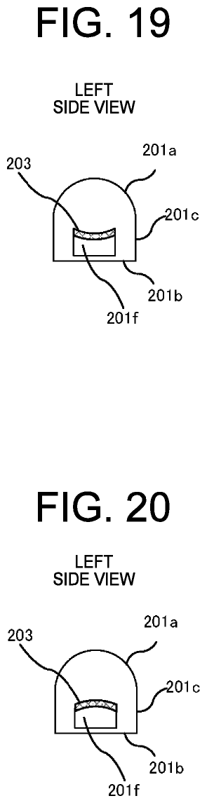

FIG. 19 illustrates a static elimination device according to the sixteenth embodiment. The difference from the static elimination device according to the fourteenth embodiment illustrated in FIG. 18 is that, in the static elimination device according to the fourteenth embodiment, the cross-sectional shape of the top of the first hollow hole 201f is linear, whereas in the static elimination device according to the sixteenth embodiment, the cross-sectional shape of the top of the first hollow hole 201f is a recessed shape such that the closer the cross-sectional shape of the top of the first hollow hole 201f is to the center of the top, the closer the cross-sectional shape of the top of the first hollow hole 201f is to the bottom.

Therefore, even if the protruding shape of the facing surface 201a is the same as that of the fourteenth embodiment, the width in the short direction of the light emitted from the facing surface 201a can be narrowed compared to the fourteenth embodiment.

### Seventeenth Embodiment

FIG. 20 illustrates a static elimination device according to the seventeenth embodiment. The difference from the static elimination device according to the fourteenth embodiment illustrated in FIG. 18 is that, in the static elimination device according to the fourteenth embodiment, the cross-sectional shape of the top of the first hollow hole 201f is linear, whereas in the static elimination device according to the seventeenth embodiment, the cross-sectional shape of the top of the first hollow hole 201f is a protruding shape such that the closer the cross-sectional shape of the top of the first hollow hole 201f is to the center of the top, the further the cross-sectional shape of the top of the first hollow hole 201f is from the bottom.

Therefore, even if the protruding shape of the facing surface 201a is the same as that of the fourteenth embodiment, the width in the short direction of the light emitted from the facing surface 201a can be widened compared with the fourteenth embodiment.

### Eighteenth Embodiment

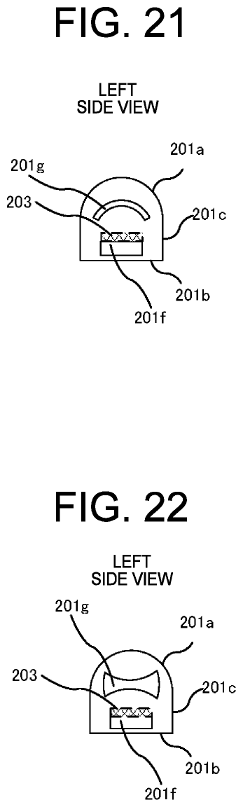

FIG. 21 illustrates a static elimination device according to the eighteenth embodiment. The difference from the static elimination device according to the fourteenth embodiment illustrated in FIG. 18 is that, in the static elimination device according to the fourteenth embodiment, no holes other than the first hollow hole 201f are provided in the light guide member 201, whereas in the static elimination device according to the eighteenth embodiment, a first hollow hole 201f and a second hollow hole 201g are provided in the light guide member 201.

By adjusting the cross-sectional shape of the second hollow hole 201g, a cylindrical convex lens or concave lens can be configured. For example, if a convex lens is configured, even if the protruding shape of the facing surface 201a is the same as that of the fourteenth embodiment, the width in the short direction of the light emitted from the facing surface 201a can be narrowed compared to the fourteenth embodiment. On the other hand, if a concave lens is configured, even if the protruding shape of the facing surface 201a is the same as that of the fourteenth embodiment, the width in the short direction of the light emitted from the facing surface 201a can be widened compared to the fourteenth embodiment.

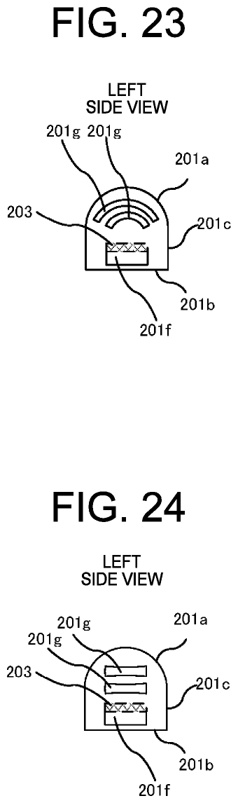

FIG. 22 illustrates an example in which two convex lenses are formed by the second hollow hole 201g. FIG. 23 illustrates an example in which a plurality of second hollow holes are provided. FIG. 24 illustrates an example in which three convex lenses are formed by two hollow holes 201g.

### Nineteenth Embodiment

In the above-described embodiment, the light guide member 201 has the same cross-sectional shape in the whole area in the longitudinal direction. In addition, the diffused reflection surface 203 is provided in the whole area in the longitudinal direction of the reflection members 221, 231, 233, 235, 237 and 239, and the light guide member 201.

However, the extension area in the longitudinal direction may be changed from the whole area to a partial area as long as the uniformity of the static elimination light exceeds a certain level in the main scanning direction of the image forming region of the photosensitive drum 21. For example, this is possible if the total length of the light guide member 201 exceeds the length of the image forming region of the photosensitive drum 21 in the main scanning direction to some extent.

Regardless of having openings at both ends or only at one end, as long as a certain degree of uniformity of static elimination light is maintained in the main scanning direction of the image forming region of the photosensitive drum 21, the extension area in the longitudinal direction may be changed in the first hollow hole 201f and the second hollow hole 201g.

### Twentieth Embodiment

In order to correct the distribution in the longitudinal direction of the intensity of the light emitted from the light guide member 201, for example, the width in the short direction of the diffused reflection surface 203 may be adjusted to be different depending on a position in the longitudinal direction, the width of the reflection members 231, 233, 235, 237 and 239 may be adjusted to be different depending on a position in the longitudinal direction, the reflectance of the reflection members 231, 233, 235, 237 and 239 may be adjusted to be different depending on a position in the longitudinal direction, or the width of the groove 201d may be adjusted to be different depending on a position in the longitudinal direction.

For example, if there is a distribution in which the intensity of the light emitted from the light guide member 201 decreases as the distance from the light source increases in the longitudinal direction, this distribution can be corrected to be constant by the above-described adjustment.

In addition, if light is incident from both ends of the light guide member 201, the intensity of the light emitted from the light guide member 201 is distributed in the longitudinal direction with the center in the longitudinal direction as the center of symmetry. This can be corrected in the same way.

### INDUSTRIAL APPLICABILITY

The present invention is used for static elimination.

### DESCRIPTION OF REFERENCE NUMERALS

21 photosensitive drum
24 charging device
32, 200 static elimination device
201 light guide member
201a facing surface
201b opposite surface
201c side face
201d groove
201e bottom of groove
201f first hollow hole
201g second hollow hole
201h, 201j, 201k, 201m light entrance portion
203 diffused reflection surface
221, 231, 233, 235, 237, 239 reflection member
301, 303, 305 light source

What is claimed is:

1. A light guide member rod-like in shape and usable in a static elimination device for eliminating static electricity from a static elimination object with light, the light guide member including:
a facing surface that is a surface facing the static elimination object when viewed in cross section and has an invariable protruding shape in a protruding surface shape area as a first predetermined area of at least a part in a longitudinal direction; and
a diffused reflection surface provided at a position on an opposite surface to the facing surface or a position inside the light guide member within a predetermined distance from the opposite surface in a diffused reflection surface area as a second predetermined area of at least a part in the longitudinal direction, the second predetermined area being identical to or different from the first predetermined area.

2. The light guide member according to claim 1, wherein light that has entered the light guide member through a light entrance portion, has been diffused by the diffused reflection surface, and has reached the protruding surface shape area of the facing surface is refracted to allow the light emitted from the protruding surface shape area to be more approximate to parallel light than before being refracted over the protruding surface shape area when viewed in cross section.

3. The light guide member according to claim 1, which includes a reflection surface reflecting light that is provided on at least one end face in the longitudinal direction.

4. The light guide member according to claim 1, which comprises a reflection member corresponding to at least the diffused reflection surface.

5. The light guide member according to claim 1, which comprises a reflection member corresponding to at least a part of a side face located between the facing surface and the opposite surface.

6. The light guide member according to claim 1,
wherein a groove extending in the longitudinal direction that is opened to the opposite surface is formed at least in the diffused reflection surface area, and
wherein the diffused reflection surface is provided at a bottom of the groove.

7. The light guide member according to claim 6, wherein the bottom of the groove has a linear shape, a protruding shape or a recessed shape when viewed in cross section.

8. The light guide member according to claim 6, wherein a reflection member corresponding to the diffused reflection surface is disposed at the bottom of the groove adjacently to the diffused reflection surface.

9. The light guide member according to claim 6, wherein a reflection member corresponding to the diffused reflection surface is disposed at a distance from the diffused reflection surface so as to cover the groove.

10. The light guide member according to claim 9, wherein the reflection member corresponding to the diffused reflection surface is also disposed on an inner face of the groove.

11. The light guide member according to claim 1, which includes a first hollow hole extending from one end to a different end in the longitudinal direction or from the one end in the longitudinal direction to a first intermediate position in the longitudinal direction,
wherein the diffused reflection surface is provided on an inner wall on a static elimination object side of the first hollow hole.

12. The light guide member according to claim 11, wherein the inner wall on the static elimination object side of the first hollow hole has a linear shape, a protruding shape or a recessed shape when viewed in cross section.

13. The light guide member according to claim 11, wherein a second light guide member higher in refractive index than the light guide member is disposed in the first hollow hole.

14. The light guide member according to claim 11, which includes one or more second hollow holes extending from the one end to the different end in the longitudinal direction or from the one end in the longitudinal direction to a second intermediate position in the longitudinal direction, the second intermediate position being identical to or different from the first intermediate position,
wherein the one or more second hollow holes constitute a lens.

15. A static elimination device comprising:
the light guide member according to claim 1; and
one or more light sources that make light enter the light guide member through one or both of two end faces in the longitudinal direction of the light guide member.

16. A static elimination device comprising:
the light guide member according to claim 6; and
one or more light sources that make light enter the light guide member through one or both of two end faces in the longitudinal direction of the light guide member.

17. A static elimination device comprising:
the light guide member according to claim 6; and
one or more light sources that make light enter the groove through one or both of two openings of the groove.

18. A static elimination device comprising:
the light guide member according to claim 11; and
one or more light sources that make light enter the first hollow hole through an opening or openings at one or both of two ends in the longitudinal direction of the first hollow hole.

19. A multifunction machine comprising the static elimination device according to claim 15.
